(19) United States
(12) Patent Application Publication
(10) Pub. No.: US 2003/0007304 A1
(43) Pub. Date: Jan. 9, 2003

(54) Integrated DC shunt and contactor and method of manufacture

(76) Inventors: Jay Merkle, LaGrangewille, NY (US); Erland Hagman, New Fairfield, CT (US); Stephen Langdon, Sandy Hook, CT (US)

Correspondence Address: JOHN H CROZIER, 1934 HUNTINGTON TURNPIKE, TRUMBULL, CT, 06611

(21) Appl. No.: 10/160,996

(22) Filed: Jun. 3, 2002

Related U.S. Application Data
(60) Provisional application No. 60/295,266, filed on Jun. 1, 2001.

(51) Int. Cl. H01H 47/00

(52) U.S. Cl. 361/139

(57) ABSTRACT

In a preferred embodiment, an integrated DC shunt and contactor, including; a contactor (30); a shunt assembly (52): and the shunt assembly being connected directly to the contactor without any intervening electrically conductive materials disposed therebetween.

### CROSS-REFERENCE TO RELATED APPLICATION

Benefit is claimed of the filing date of U.S. Provisional Application Serial No. 60/295,266, filed Jun. 1, 2001, and titled INTEGRATED DC SHUNT AND CONTACTOR.

### BACKGROUND OF THE INVENTION

1. Field of the Invention

The present invention relates to power distribution units generally and, more particularly, but not by way of limitation, to a novel integrated DC shunt and contactor useful for power distribution units.

2. Background Art

Power distribution units (PDUs) typically employ various rectifiers, ammeters, shunts, contactors, buses, and the like. In known power distribution units, shunts and contactors are separate, discrete elements that require interconnecting wiring. This somewhat complicates installation in that the shunts and contactors require interconnecting wiring.

As is well known in the art, in PDUs, generally the DC contactor resides next to the rectifiers as disconnect between the system load and the battery pack. It allows a small charge current to flow from the rectifiers to the batteries during normal operation of the rectifiers. It also disconnects the battery from the load when the batteries drop below a certain voltage, hence protecting the battery from failure. The DC shunt is used with the controller in the system, the purpose of which controller is to measure the current during both the charging and the discharging phases.

Accordingly, it is a principal object of the present invention to provide an integrated DC shunt and contactor that does not require interconnecting wiring or bus bars between the contactor and the shunt.

It is a further object of the invention to provide such an integrated DC shunt and contactor that is simply constructed.

Other objects of the present invention, as well as particular features, elements, and advantages thereof, will be elucidated in, or be apparent from, the following description and the accompanying drawing figures.

### SUMMARY OF THE INVENTION

The present invention achieves the above objects, among others, by providing, in a preferred embodiment, an integrated DC shunt and contactor, comprising; a contactor; a shunt assembly: and said shunt assembly being connected directly to said contactor without any intervening electrically conductive materials disposed therebetween.

### BRIEF DESCRIPTION OF THE DRAWING

Understanding of the present invention and the various aspects thereof will be facilitated by reference to the accompanying drawing figures, provided for purposes of illustration only and not intended to define the scope of the invention, on which:

FIG. 1 is an isometric view of one embodiment of the present invention.

FIG. 2 is an isometric view of another embodiment of the present invention.

### DETAILED DESCRIPTION OF THE PREFERRED EMBODIMENTS

Reference should now be made to the drawing figures on which similar or identical elements are given consistent identifying numerals throughout the various figures thereof, and on which parenthetical references to figure numbers direct the reader to the view(s) on which the element(s) being described is (are) best seen, although the element(s) may be seen on other figures also.

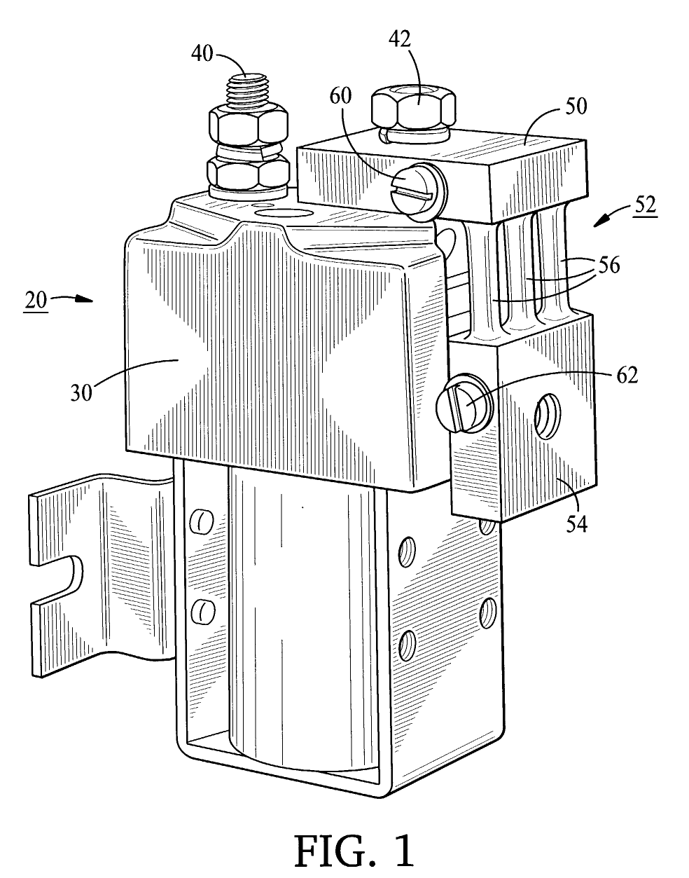

FIG. 1 illustrates one embodiment of an integrated DC shunt and contactor, the device being generally indicated by the reference numeral 20. Device 20 includes a standard contactor 30 which may be a Model SW180-507L w/200A-30 mV.tif, as furnished by Curtis Instruments, Inc., of Mt. Kisco, N.Y. Device 20 includes first and second load studs 40 and 42.

Removably attached to second load stud 42 by suitable means is a first end 50 of a shunt assembly 52, the shunt assembly having a second end 54 with a threaded opening defined therein for the connection thereto of electrical apparatus (not shown), and with the shunt itself 56 disposed between the first and second ends. Connections 60 and 62 are provided, respectively, on first and second ends 50 and 54 of shunt assembly 52 for connection to an ammeter (not shown) of the power distribution unit (PDU). It will be understood that shunt assembly is a “bolt-on” unit that can be installed on a standard contactor 30 during manufacturing or in the field.

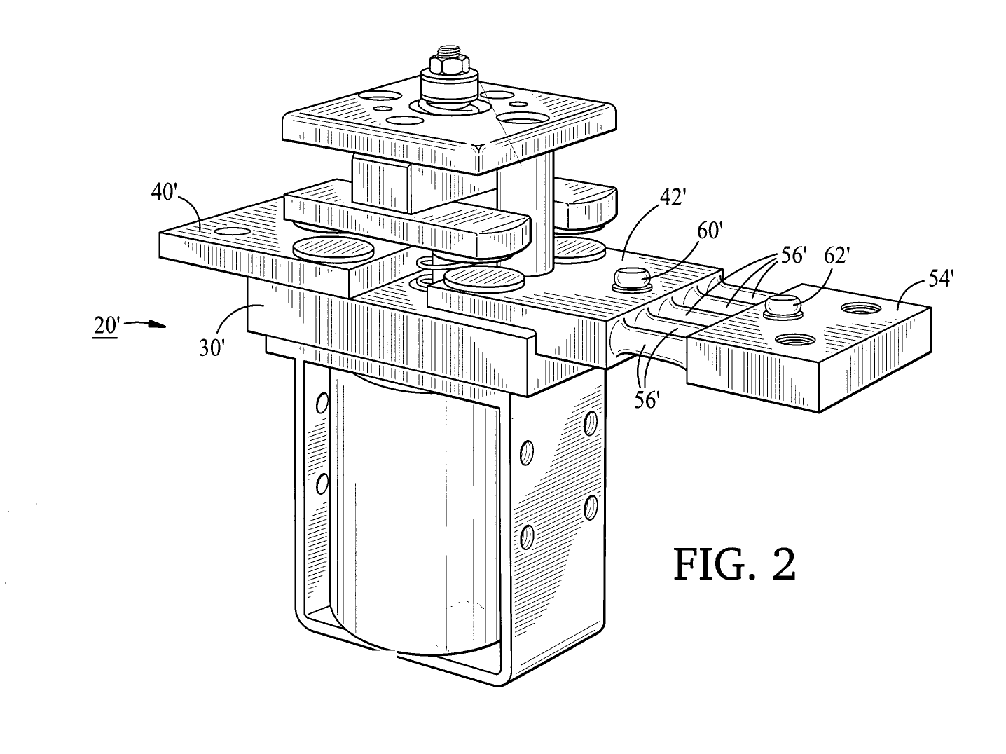

FIG. 2 illustrates another embodiment of the present invention, the elements of this device, 20′, having similar structure or function to elements of device 20 (FIG. 1) being given primed reference numerals. Device 20′ may be a Model SW600-6 w/600A-30 mV.tif, as furnished by Curtis Instruments, Inc., of Mt. Kisco, N.Y. Device 20′ is similar to device 20 except that first and second load studs 40 and 42 have been replaced with first and second bus mounting bars 40′ and 42′. Shunt 56′, in this case, is disposed between second bus mounting bar 42′ and second end 54′ which has a pair of threaded openings defined therethrough for the attachment of electrical apparatus (not shown). Connections 60′ and 62′ are provided for connection to an ammeter (not shown). It will be understood that device 20′ can be easily manufactured.

The advantages of the present invention over the convention arrangement are:

It provides a substantial reduction in wiring.

It is easier to install, eliminating installation steps.

It saves space by providing a single component configuration which reduces overall footprint, maximizes optimum space, and installation efficiency.

These advantages accrue, in part, because the invention eliminates the testing at connection points. Also, at each connection point, there is some resistance that contributes to heat buildup in the power distribution cabinet.

In the embodiments of the present invention described above, it will be recognized that individual elements and/or features thereof are not necessarily limited to a particular embodiment but, where applicable, are interchangeable and can be used in any selected embodiment even though such may not be specifically shown.

Terms such as “upper”, “lower”, “inner”, “outer”, “inwardly”, “outwardly”, “vertical”, “horizontal”, and the like, when used herein, refer to the positions of the respective elements shown on the accompanying drawing figures and the present invention is not necessarily limited to such positions.

It will thus be seen that the objects set forth above, among those elucidated in, or made apparent from, the preceding description, are efficiently attained and, since certain changes may be made in the above construction without departing from the scope of the invention, it is intended that all matter contained in the above description or shown on the accompanying drawing figures shall be interpreted as illustrative only and not in a limiting sense.

It is also to be understood that the following claims are intended to cover all of the generic and specific features of the invention herein described and all statements of the scope of the invention which, as a matter of language, might be said to fall therebetween.

The embodiments of the invention in which an exclusive property or privilege is claimed are defined as follows:

1. An integrated DC shunt and contactor, comprising;
(a) a contactor;
(b) a shunt assembly: and
(c) said shunt assembly being connected directly to said contactor without any intervening electrically conductive materials disposed therebetween.

2. An integrated DC shunt and contactor, as defined in claim 1, wherein: said shunt assembly has first and second ends, with a shunt disposed therebetween, and said shunt assembly is attached to said contactor by means of said first end being connected to a load stud on said contactor.

3. An integrated DC shunt and contactor, as defined in claim 2, wherein: said first and second ends of said shunt assembly have connections thereon for the attachment thereto of an ammeter.

4. An integrated DC shunt and contactor, as defined in claim 2, wherein: said second end of said shunt assembly has at least one connection thereon for the attachment thereto of electrical apparatus.

5. A method of manufacturing an integrated DC shunt and contactor, comprising the steps of:
(a) providing a contactor;
(b) providing a shunt assembly; and
(c) attaching said shunt to said contactor without any intervening electrically conductive materials disposed therebetween.

6. A method of manufacturing an integrated DC shunt and contactor, as defined in claim 5, further comprising: providing said shunt assembly with first and second ends, with a shunt disposed therebetween, and attaching said shunt assembly to said contactor by connecting said first end of said shunt assembly to a load stud on said contactor.

7. A method of manufacturing an integrated DC shunt and contactor, as defined in claim 6, further comprising: providing said first and second ends of said shunt assembly having connections thereon for the attachment thereto of an ammeter.

8. A method of manufacturing an integrated DC shunt and contactor, as defined in claim 6, further comprising: providing said second end of said shunt assembly having at least one connection thereon for the attachment thereto of electrical apparatus.
